(19) United States
(12) Patent Application Publication
(10) Pub. No.: US 2020/0067207 A1
(43) Pub. Date: Feb. 27, 2020

(54) JOINT STRUCTURE OF COATED ELECTRIC WIRE AND TERMINAL AND JOINING METHOD OF COATED ELECTRIC WIRE AND TERMINAL

(71) Applicant: YAZAKI CORPORATION, Tokyo (JP)

(72) Inventors: Satoshi Saito, Shizuoka (JP); Takahiro Saito, Shizuoka (JP)

(21) Appl. No.: 16/536,316

(22) Filed: Aug. 9, 2019

(30) Foreign Application Priority Data
Aug. 21, 2018 (JP) 2018-154551

(51) Int. Cl. H01R 4/02; H01R 43/02

(52) U.S. Cl. CPC H01R 4/023; H01R 43/02

(57) ABSTRACT

In a joint structure of coated electric wire and terminal, a core wire pressure welding range and a coated pressure welding range are inserted into a cylindrical portion of the terminal from an opening thereof. The cylindrical portion is uniformly reduced in diameter in a deformation direction by an electromagnetic pressure welding method, and thereby the core wire pressure welding range and the coated pressure welding range of the coating are pressure welded with the cylindrical portion. A joining method of coated electric wire and terminal includes a first step of forming a core wire exposed range to the coated electric wire, a second step of inserting the core wire exposed range and a part of the coating into the cylindrical portion, a third step of inserting the cylindrical portion into a discharge coil, and a fourth step of causing a discharge current to instantaneously flow through the discharge coil.

### CROSS-REFERENCE TO RELATED APPLICATIONS

This application is based on and claims priority under 35 USC 119 from Japanese Patent Application No. 2018-154551 filed on Aug. 21, 2018, the contents of which are incorporated herein by reference.

### TECHNICAL FIELD

The present invention relates to a joint structure of a coated electric wire and a terminal, and a joining method of a coated electric wire and a terminal, and particularly relates to a joint structure of a coated electric wire and a terminal in which a core wire and a part of a coating surrounding the core wire are joined to the terminal, and a joining method of a coated electric wire and a terminal.

### BACKGROUND ART

In related art, in a joint structure of a coated electric wire and a terminal in which the coated electric wire including a core wire made of aluminum or aluminum alloy and an insulating coating surrounding the core wire is connected to a copper or copper alloy terminal, a part of the core wire that is stripped and exposed (hereinafter referred to as “core wire exposed portion”) and a predetermined range of coating near the exposed portion are inserted into a cylindrical portion that is a part of the terminal, and then the cylindrical portion is mechanically crimped. That is, a pair of molds including substantially semi-cylindrical concave portions is brought close to each other to perform to flatten the cylindrical portion.

Therefore, an inner surface of the cylindrical portion and an outer surface of the core wire, as well as the inner surface of the cylindrical portion and an outer surface of the coating are pressure welded in a pressing direction, but a gap (hereinafter, referred to as a “lateral gap”) is generated in a direction perpendicular to the pressing direction.

As a result, water may enter through the lateral gap formed between the inner surface of the cylindrical portion and the outer surface of the coating, and a contact portion between the cylindrical portion and the core wire may corrode. In particular, some anti-corrosion treatment or waterproof treatment is required, for example, when the structure is mounted at a site where “water contact” occurs.

Therefore, an invention is disclosed in which an “adhesive member” for waterproofing is provided between the inner surface of the cylindrical portion and the outer surface of the coating (for example, see Patent Document 1).

Patent Document 1: JP-A-2018-6160 (Pages 6 to7, FIG. 2)

### SUMMARY OF INVENTION

In the invention disclosed in Patent Document 1, the adhesive member is wound around the outer surface of the coating, and the coating and the adhesive member wound around the outer surface of the coating are inserted into the cylindrical portion, and then the cylindrical portion is crimped. At this time, the adhesive member includes a base material having flexibility, an adhesive that is disposed on one surface of the base material and adheres to the coating, an adhesive that is disposed on the other surface of the base material and adheres to the cylindrical portion, and a release paper that covers the adhesive on the other surface to allow insertion into the cylindrical portion.

For this reason, production cost increases since the adhesive member has a complicated structure of four layers. In addition, removal of only the release paper is required after insertion into the cylindrical portion and before crimping, but operation is complicated and difficult and construction cost increases. At this time, if the adhesive member is made thin in order to facilitate the insertion into the cylindrical portion and the removal of only the release paper, or if the adhesive member is thickened in order to improve waterproofness, workability decreases.

An object of the present invention is to solve the above problem, and to provide, at low cost, a joint structure of a coated electric wire and a terminal, having high waterproofness, and a joining method of a coated electric wire and a terminal.

A joint structure of a coated electric wire and a terminal according to the present invention is to join the coated electric wire that includes a conductive core wire and an insulating coating surrounding a side surface of the core wire to a conductive terminal that includes a closed cylindrical portion having an opening formed at only on one end portion. The coating is removed in a predetermined range from an end portion of the coated electric wire, and a core wire pressure welding range where the core wire is exposed and a coated pressure welding range of the coating that is a predetermined range from the core wire pressure welding range are respectively pressure welded with the cylindrical portion.

In addition, the cylindrical portion is disposed inside a discharge coil having a substantially C-shaped cross section, and is reduced in diameter by an electromagnetic force based on an induced current generated in the cylindrical portion by a discharge current instantaneously supplied to the discharge coil and an induced magnetic field generated between the discharge coil and the cylindrical portion by the induced current.

Further, a joining method of a coated electric wire and a terminal according to the present invention is to join the coated electric wire that includes a conductive core wire and an insulating coating surrounding a side surface of the core wire to a conductive terminal that includes a closed cylindrical portion having an opening formed at only on one end portion. The joining method includes a first step of removing the coating from an end portion of the coated electric wire in a predetermined range to form a core wire exposed range of the core wire; a second step of inserting the core wire exposed range and a coated insertion range of the coating that is a predetermined range from the core wire exposed range to the cylindrical portion from the opening; a third step of inserting the cylindrical portion in which the core wire exposed range and the coated insertion range are inserted into a discharge coil having a substantially C-shaped cross section; a fourth step of causing a discharge current to instantaneously flow through the discharge coil; and a fifth step of pressure welding an outer surface of the core wire exposed range and an outer surface of the coated insertion range respectively to an inner surface of the cylindrical portion by reducing in diameter of the cylindrical portion with an electromagnetic force based on an induced current generated in the cylindrical portion by the discharge current and an induced magnetic field generated between the discharge coil and the cylindrical portion by the induced current.

In the joint structure of the coated electric wire and the terminal according to the present invention, since the core wire exposed range and the coated pressure welding range are pressure welded with the cylindrical portion, the adhesive member or the like is not required, which lowers the cost. In addition, since pressure welding is performed by an electromagnetic pressure welding method, conductivity and waterproofness are ensured.

Further, since the joint structure of the coated electric wire and the terminal according to the invention is based on the electromagnetic pressure welding method, the cylindrical portion is reduced in diameter uniformly in a circumferential direction by the electromagnetic force, so that the core wire exposed range and the coated pressure welding range are uniformly pressure welded with the cylindrical portion in the circumferential direction, whereby good conductivity and waterproofness can be obtained at low cost.

### BRIEF DESCRIPTION OF DRAWINGS

FIGS. 1A and 1B are views showing a joint structure of a coated electric wire and a terminal according to a first embodiment, in which FIG. 1A is a perspective view showing a part (an electric wire), and FIG. 1B is a perspective view showing a part (a terminal).

FIGS. 2A and 2B are views showing the joint structure of the coated electric wire and the terminal according to the first embodiment, in which FIG. 2A is a perspective view and FIG. 2B is a cross-sectional view

FIG. 3 is a flowchart showing a joining method of a coated electric wire and a terminal according to a second embodiment.

FIGS. 4A and 4B are views showing the joining method of the coated electric wire and the terminal according to the second embodiment, in which FIG. 4A is a perspective view showing a second step and FIG. 4B is a cross-sectional view showing the second step.

FIG. 5 is a perspective view showing a third step for explaining the joining method of the coated electric wire and the terminal according to the second embodiment.

FIG. 6 is a cross-sectional front view of a fourth step (an electromagnetic pressure welding method) for explaining the joining method of the coated electric wire and the terminal according to the second embodiment.

### DESCRIPTION OF EMBODIMENTS

Hereinafter, a joint structure of a coated electric wire and a terminal according to a first embodiment of the present invention and a joining method of a coated electric wire and a terminal according to a second embodiment of the present invention will be described with reference to the drawings. It should be noted that shapes and sizes of members depicted in the drawing or gaps or positional relationships between the members are not limited to the illustrated embodiment.

### First Embodiment

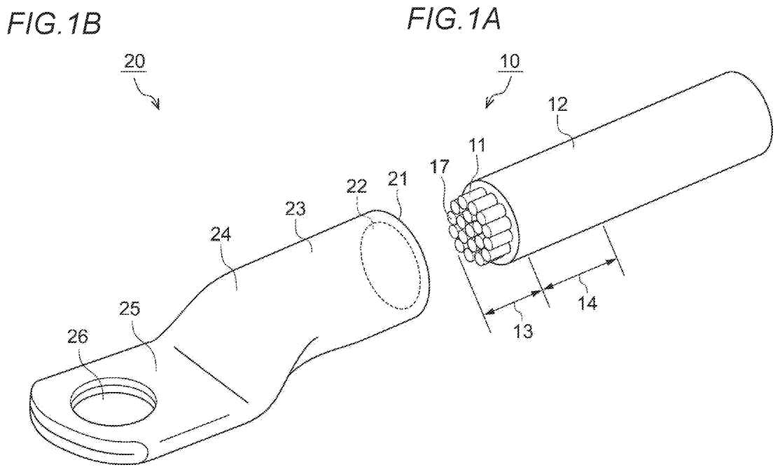

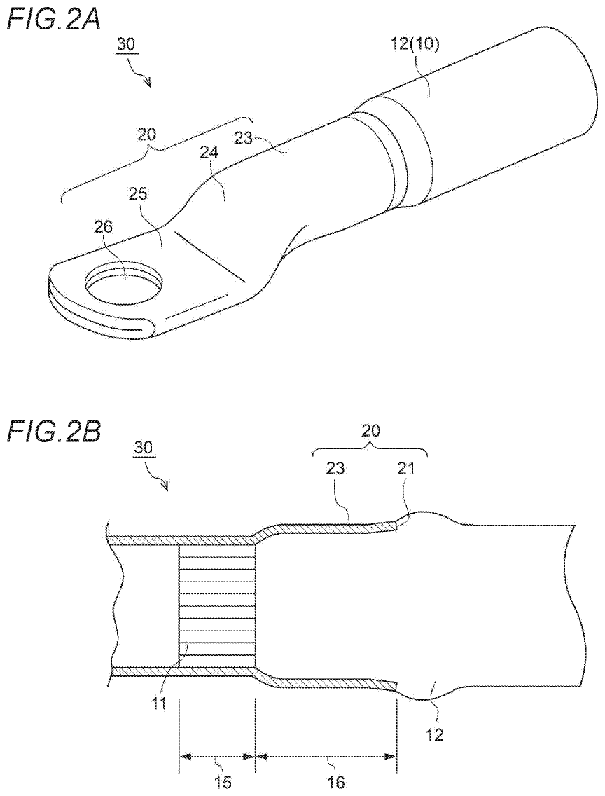

FIGS. 1A and 1B and FIGS. 2A and 2B are views showing a joint structure of a coated electric wire and a terminal according to a first embodiment. FIG. 1A is a perspective view showing a part (an electric wire), FIG. 1B is a perspective view showing a part (terminal), FIG. 2A is a perspective view of the joint structure of the coated electric wire and the terminal, and FIG. 2B is a cross-sectional view of the joint structure of the coated electric wire and the terminal.

### (Coated Electric Wire)

In FIG. 1A, a coated electric wire 10 includes a conductive core wire 11 and an insulating coating 12 surrounding a side surface of the core wire 11, and the coating 12 is removed from an end portion in a predetermined range, so that a range where the core wire 11 is exposed (hereinafter, referred to as a “core wire exposed range 13”) is formed. The coating 12 in a predetermined range from the core wire exposed range 13 is referred to as a “coated insertion range 14”.

Further, the core wire 11 is formed by bundling aluminum or aluminum alloy strands 17 (not limited in quantity), but the invention is not limited thereto.

### (Terminal)

In FIG. 1B, a terminal 20 includes a cylindrical portion 23 having a circular cross section in which an opening 22 (shown by a broken line) is formed in one end surface 21, a flat portion 24 connected to the other end portion of the cylindrical portion 23 and gradually flattened, a two-plate-like flat plate portion 25 connected to the flat portion 24, and a through hole 26 formed in the flat plate portion 25. That is, the cylindrical portion 23 is closed by the flat portion 24.

The terminal 20 is an “integrated object” formed by molding a tubular body, but the invention is not limited thereto, and may be a combination of a plurality of members made of the same or different materials. In addition, a three-dimensional portion may be provided instead of the flat plate portion 25. Further, the terminal 20 is made of copper or copper alloy, but the invention is not limited thereto. For example, the core wire 11 may be made of copper or copper alloy, and the terminal 20 may be made of aluminum or aluminum alloy.

### (Joint Structure of Coated Electric Wire and Terminal)

In FIGS. 2A and 2B, a joint structure 30 of the coated electric wire and the terminal (hereinafter, simply referred to as a “joint structure”) is formed by joining the coated electric wire 10 to the terminal 20.

That is, the core wire exposed range 13 and the coated insertion range 14 of the coated electric wire 10 are inserted into the cylindrical portion 23 from the opening 22, and the cylindrical portion 23 is reduced in diameter by an electromagnetic pressure welding method (described in detail below). Therefore, an outer surface of a range (hereinafter, referred to as a “core wire pressure welding range 15”) of the core wire 11 corresponding to the core wire exposed range 13 and an outer surface of a range (hereafter, referred to as a “coated pressure welding range 16”) of the coating 12 corresponding to the coated insertion range 14 are respectively pressure welded with an inner surface of the cylindrical portion 23.

Since the coated insertion range 14 is radially compressed and axially stretched along with diameter reduction of the cylindrical portion 23, the coated pressure welding range 16 is longer than the coated insertion range 14, and conversely, the core wire pressure welding range 15 is shorter than the core wire exposed range 13. In the cylindrical portion 23, a boundary between the core wire pressure welding range 15 and the coated pressure welding range 16 is gradually enlarged in diameter toward the end surface 21, and a range of the coated pressure welding range 16 close to the end surface 21 has a truncated cone shape slightly enlarged in diameter at an angle larger than that of the end surface 21. Since the cylindrical portion 23 is reduced in diameter even after the outer surface of the coated pressure welding range 16 is pressure welded with the inner surface of the cylindrical portion 23, compressed air is considered to be sealed therein.

### (Function and Effects)

Since the joint structure 30 is manufactured by the electromagnetic pressure welding method and the cylindrical portion 23 is uniformly reduced in diameter in a circumferential direction, the core wire 11 are uniformly pressure welded with the cylindrical portion 23 in the core wire pressure welding range 15, so that good conductivity can be obtained. Further, since the coating 12 is uniformly pressure welded with the cylindrical portion 23 in the coated pressure welding range 16, good waterproofness can be obtained. At this time, since the coating 12 also enters between the strands 17 forming the core wire 11, adhesion degree between outer surfaces of the strands 17 and an inner surface of the coating 12 is also improved.

Therefore, the cylindrical portion 23 is completely closed to prevent water, and corrosion does not occur between the core wire 11 and the cylindrical portion 23.

### Second Embodiment

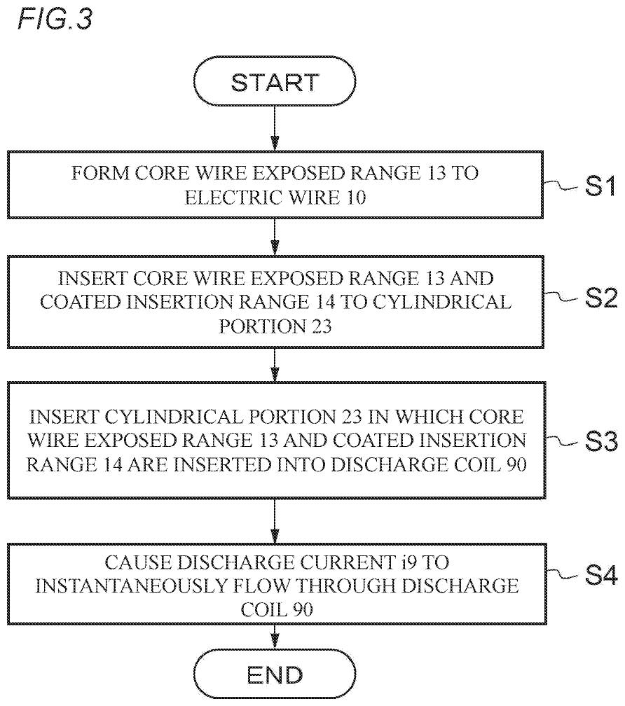

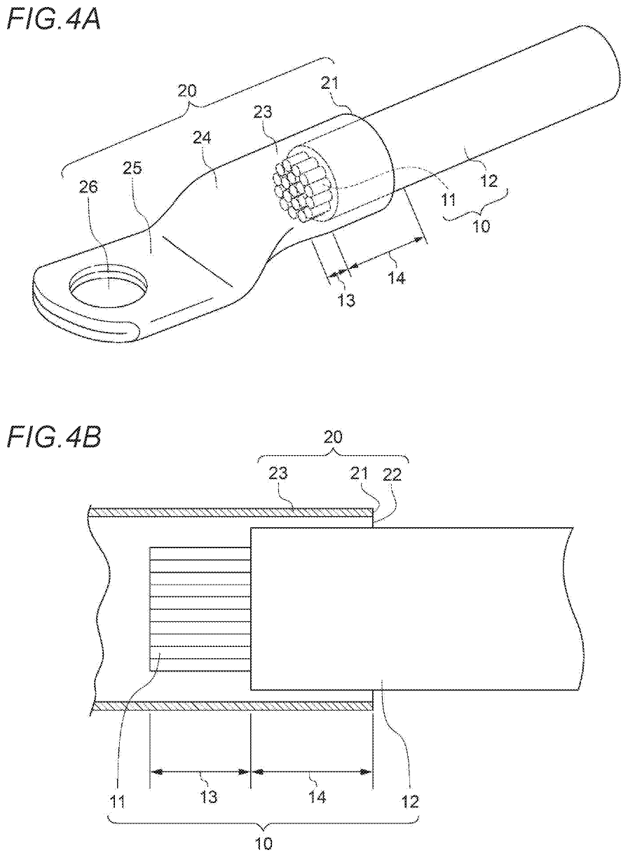

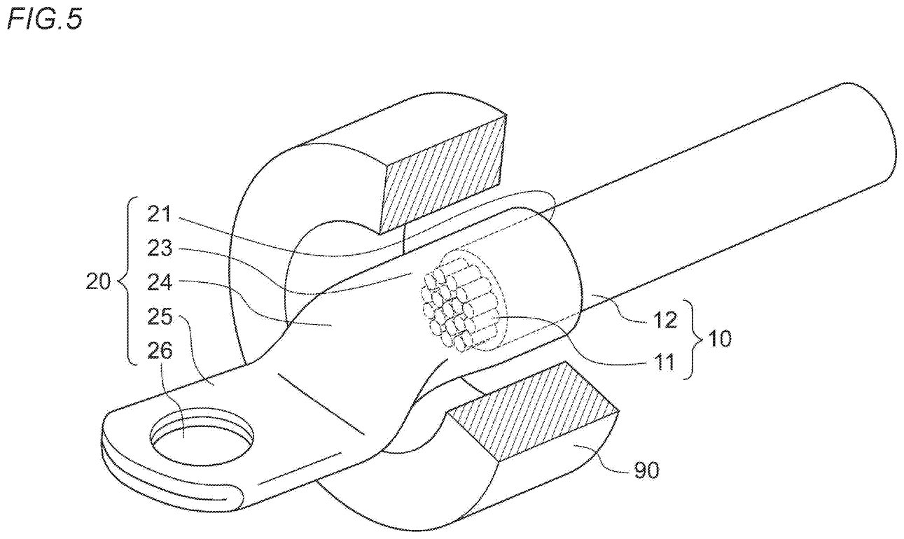

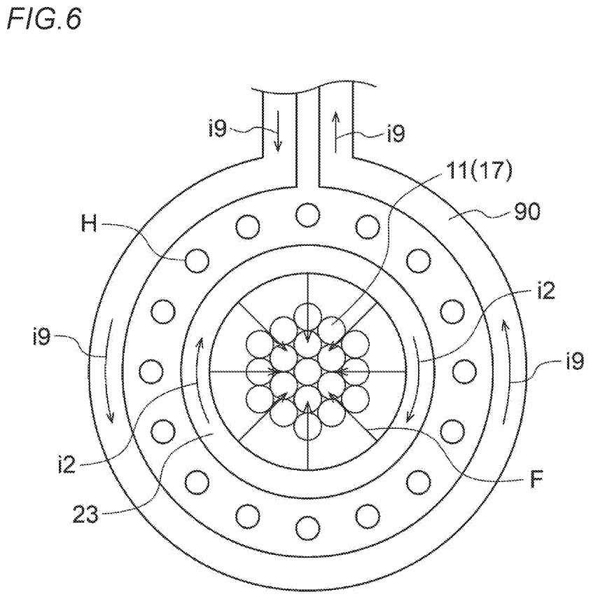

FIGS. 3 to 6 are views showing a joining method of a coated electric wire and a terminal according to a second embodiment, in which FIG. 3 is a flow chart, FIG. 4A is a perspective view showing a second step, FIG. 4B is a cross-sectional view showing the second step, FIG. 5 is a perspective view showing a third step, and FIG. 6 is a cross-sectional view showing a fourth step (an electromagnetic pressure welding method). The same parts or corresponding parts as those in the first embodiment are denoted by the same names and reference numerals, and a description thereof will be omitted.

### (Joining Method of Coated Electric Wire and Terminal)

In FIGS. 3 to 6, the joining method of the coated electric wire and the terminal according to the second embodiment is a method of joining the coated electric wire 10 to the terminal 20 by the electromagnetic pressure welding method, and includes the following steps.

That is, the joining method of the coated electric wire and the terminal includes a first step (S1, see FIG. 1A) of removing the coating 12 from an end portion of the coated electric wire 10 in a predetermined range to form the core wire exposed range 13 of the core wire 11; a second step (S2, see FIGS. 4A and 4B) of inserting the core wire exposed range 13 and the coated insertion range 14 of the coating 12 that is a predetermined range from the core wire exposed range 13 to the cylindrical portion 23 from the opening 22; a third step (S3, see FIG. 5) of inserting the cylindrical portion 23 in which the core wire exposed range 13 and the coated insertion range 14 are inserted into a discharge coil 90 having a substantially C-shaped cross section; and a fourth step (S4, see FIG. 6) of causing a discharge current i9 to instantaneously flow through the discharge coil 90. Further, the joining method includes a fifth step of pressure welding an outer surface of the core wire exposed range and an outer surface of the coated insertion range respectively to an inner surface of the cylindrical portion by reducing in diameter of the cylindrical portion with an electromagnetic force based on an induced current generated in the cylindrical portion by the discharge current and an induced magnetic field generated between the discharge coil and the cylindrical portion by the induced current.

(Electromagnetic Pressure Welding Method)

In FIG. 6, when the discharge current i9 (counterclockwise direction in FIG. 6) flows through the discharge coil 90, a magnetic field H (perpendicular to a paper surface in FIG. 9) is generated between the outer discharge coil 90 and the inner cylindrical portion 23 by the discharge current i9 (Ampere's right handed screw rule). At this time, an induced current i2 (clockwise direction in FIG. 9) is generated in the cylindrical portion 23 by electromagnetic induction (Lenz's law and Ampere's right hand screw rule).

Therefore, an electromagnetic force F in a diameter reducing direction based on the magnetic field H and the induced current i2 functions on the cylindrical portion 23 (Fleming's left hand rule). Then, the cylindrical portion 23 is uniformly reduced in diameter in the circumferential direction by the electromagnetic force F. At this time, since the coating 12 in the coated insertion range 14 is radially compressed and axially stretched, the coating 12 is pressure welded with the cylindrical portion 23 in the coated pressure welding range 16 that is a range longer than the coated insertion range 14, while the core wire 11 is pressure welded with the cylindrical portion 23 in the core wire pressure welding range 15 that is a range shorter than the core wire exposed range 13.

(Function and Effects)

As described above, since the joining method of the coated electric wire and the terminal according to the second embodiment includes the above-described steps, the joint structure 30 having excellent conductivity and waterproofness is provided. That is, the core wire 11 is uniformly pressure welded with the cylindrical portion 23 in the core wire pressure welding range 15, so that good conductivity is obtained, and the coating 12 is uniformly pressure welded with the cylindrical portion 23 in the coated pressure welding range 16, so that good waterproofness is obtained. At this time, since the coating 12 also enters between the strands 17 forming the core wire 11, adhesion degree between outer surfaces of the strands 17 and an inner surface of the coating 12 is also improved. Therefore, since the cylindrical portion 23 is completely closed to prevent water, corrosion does not occur between the core wire 11 and the cylindrical portion 23.

The invention has been described above based on the first and second embodiments. It should be understood by those skilled in the art that the first and second embodiments are merely examples, and various modifications can be made to components in both of the embodiments and combinations thereof, which are also within the scope of the invention.

### INDUSTRIAL APPLICABILITY

The invention has been described above, and can be widely used as a joint structure of various coated electric wires and terminals and as a joining method of various coated electric wires and terminals.

What is claimed is:

1. A joint structure of a coated electric wire and a terminal comprising:
a coated electric wire including a conductive core wire and an insulating coating which surrounds a side surface of the core wire; and
a conductive terminal including a closed cylindrical portion having an opening formed on only one end portion,
wherein a core wire pressure welding range where the core wire is exposed by removing the coating in in a predetermined range from an end portion of the coated electric wire and a coated pressure welding range of the coating that is a predetermined range from the core wire pressure welding range are respectively pressure welded with the cylindrical portion.

2. The joint structure of a coated electric wire and a terminal according to claim 1,
wherein the cylindrical portion is disposed inside a discharge coil having a substantially C-shaped cross section, and is reduced in diameter by an electromagnetic force based on an induced current generated in the cylindrical portion by a discharge current instantaneously supplied to the discharge coil and an induced magnetic field generated between the discharge coil and the cylindrical portion by the induced current.

3. A joining method of a coated electric wire and a terminal, the coated electric wire including a conductive core wire and an insulating coating which surrounds a side surface of the core wire, the terminal including a closed cylindrical portion having an opening formed on only one end portion, the joining method comprising:
a first step of removing the coating from an end portion of the coated electric wire in a predetermined range to form a core wire exposed range of the core wire;
a second step of inserting the core wire exposed range and a coated insertion range of the coating that is a predetermined range from the core wire exposed range to the cylindrical portion from the opening;
a third step of inserting the cylindrical portion in which the core wire exposed range and the coated insertion range are inserted into a discharge coil having a substantially C-shaped cross section;
a fourth step of causing a discharge current to instantaneously flow through the discharge coil; and
a fifth step of pressure welding an outer surface of the core wire exposed range and an outer surface of the coated insertion range respectively to an inner surface of the cylindrical portion by reducing in diameter of the cylindrical portion with an electromagnetic force based on an induced current generated in the cylindrical portion by the discharge current and an induced magnetic field generated between the discharge coil and the cylindrical portion by the induced current.
